(19) United States
(12) Patent Application Publication
(10) Pub. No.: US 2025/0292146 A1
(43) Pub. Date: Sep. 18, 2025

(54) IDENTIFYING SENSITIVE RANGES OF CONTINUOUS VARIABLES FOR POST-MODELING ANALYSIS

(71) Applicant: INTERNATIONAL BUSINESS MACHINES CORPORATION, ARMONK, NY (US)

(72) Inventors: Wen Pei Yu, XIAN (CN); Si Er Han, Xian (CN); Xiao Ming Ma, Xi'an (CN); Xue Ying Zhang, Xi'an (CN); Jun Wang, Xi'an (CN); Jing Xu, Xi'an (CN); Sheng Yan Sun, Beijing (CN)

(21) Appl. No.: 18/603,378

(22) Filed: Mar. 13, 2024

(51) Int. Cl. G06N 20/00

(52) U.S. Cl. CPC G06N 20/00

(57) ABSTRACT

An embodiment for generating interpretability data for a target machine learning model by determining sensitive ranges of continuous variables for post-modeling analysis. The embodiment may receive, for the target machine learning model, historical data including a series of relevant continuous variables. The embodiment may generate bins for each relevant continuous variable in the series of relevant continuous variables. The embodiment may calculate overall sensitivity values for pairs of neighbor bins. The embodiment may, in response to the calculated sensitivity value of respective pairs of neighbor bins being below a predetermined threshold value, merge the respective pairs of neighbor bins. The embodiment may generate interpretability data for the target machine learning model based on the merged respective pairs of neighbor bins.

### BACKGROUND

The present application relates generally to computer processing, and more particularly, to generating interpretability data for a target machine learning model by determining sensitive ranges of continuous variables for post-modeling analysis.

Many businesses are employing an increasing number of machine learning models for a variety of purposes related to predictive analytics, automation, risk management, enhanced decision making, customer insight analysis, and other strategic areas which may yield competitive advantages. During post-modeling analysis, businesses seek to examine and evaluate employed machine learning models that have been trained and deployed. Businesses strive to generate high quality interpretability data for post-modeling analysis of a target machine learning model to improve understanding of the target models behavior, to explain model predictions, to improve model performance, to validate domain knowledge, and to gain a wide variety of additional insights into a target machine learning model.

### SUMMARY

According to one embodiment, a method, computer system, and computer program product for generating interpretability data for a target machine learning model by determining sensitive ranges of continuous variables for post-modeling analysis is provided. The embodiment may include receiving, for the target machine learning model, historical data including a series of relevant continuous variables. The embodiment may also include generating bins for each relevant continuous variable in the series of relevant continuous variables. The embodiment may further include calculating overall sensitivity values for pairs of neighbor bins. The embodiment may also include, in response to the calculated overall sensitivity value of respective pairs of neighbor bins being below a predetermined threshold value, merging the respective pairs of neighbor bins. The embodiment may further include generating interpretability data for the target machine learning model based on the merged respective pairs of neighbor bins.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of generating interpretability data for a target machine learning model according to at least one embodiment;

FIG. 3 illustrates an exemplary workflow for a process of generating interpretability data for a target machine learning model according to at least one embodiment;

FIG. 4 illustrates an exemplary workflow for an illustrative process of determining target variance values for a pair of neighboring bins associated with historical data of a target model according to at least one embodiment;

FIG. 5 illustrates exemplary tables depicting, for a target model, an exemplary training dataset including a series of continuous variables that have been sorted by equal width binning for a selected variable ‘X₂’, and associated target variance values based on simulating records of the training dataset according to at least one embodiment; and

FIG. 6 depicts exemplary interpretability data that may be output after performing an exemplary process of generating interpretability data for a target machine learning model according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to generating interpretability data for a target machine learning model by determining sensitive ranges of continuous variables for post-modeling analysis. The following described exemplary embodiments provide a system, method, and program product to, among other things, receive, for a target machine learning model, historical data including a series of relevant continuous variables to generate bins for each of the relevant continuous variables. Described exemplary embodiments may then calculate overall sensitivity values for pairs of neighbor bins, and, in response to the calculated overall sensitivity value of respective pairs of neighbor bins being below a predetermined threshold value, merge the respective pairs of neighbor bins. Thereafter, described embodiments may generate interpretability data for the target machine learning model based on the merged respective pairs of neighbor bins, reflecting the sensitive ranges for the relevant continuous variables, and thereby providing more comprehensive and insightful interpretability data for the target machine learning model.

As previously described, many businesses are employing an increasing number of machine learning models for a variety of purposes related to predictive analytics, automation, risk management, enhanced decision making, customer insight analysis, and other strategic areas which may yield competitive advantages. During post-modeling analysis, businesses seek to examine and evaluate employed machine learning models that have been trained and deployed. Businesses strive to generate high quality interpretability data for post-modeling analysis of a target machine learning model to improve understanding of the target models behavior, to explain model predictions, to improve model performance, to validate domain knowledge, and to gain a wide variety of additional insights into a target machine learning model.

However, certain post-modeling analysis techniques generate lower quality interpretability data which provides less insights and explainability for a target machine learning model. For example, typical post-modeling analysis techniques may involve generating bar graphs illustrating feature importance for a target model. This type of interpretability data for feature importance associated with a target model, while potentially insightful for specific models in certain settings or environments, may often be ineffective for representing importance of features or continuous variables having sensitive regions for a variety of reasons. For example, bar graphs of feature importance may be insensitive to context, failing to consider differing values of a given feature and how those different values interact with other features utilized by the target model. Bar graphs of feature importance may further be misleading with respect to the importance of certain continuous variables, as sensitive ranges of a given continuous variable may be underestimated or overestimated based solely on the magnitude of its values. This type of interpretability data may involve additional challenges including but not limited to, scaling issues, difficulties with comparing sensitive ranges to more standardized ranges, and lack of explainability regarding underlying reasons for sensitivity of certain ranges of a given continuous variable. Thus, it would be advantageous to generate improved interpretability data for a target machine learning model which leverages continuous variables having sensitive ranges that require additional analysis to provide for improved model insights and explainability.

Accordingly, a method, computer system, and computer program product for generating interpretability data for a target machine learning model by determining sensitive ranges of continuous variables for post-modeling analysis is provided. The method, system, and computer program product may receive, for the target machine learning model, historical data including a series of relevant continuous variables. The method, system, computer program product may generate bins for each relevant continuous variable in the series of relevant continuous variables. The method, system, computer program product may then calculate overall sensitivity values for pairs of neighbor bins. The method, system, computer program product may, in response to the calculated overall sensitivity value of respective pairs of neighbor bins being below a predetermined threshold value, merge the respective pairs of neighbor bins. Thereafter, the method, system, computer program product may generate interpretability data for the target machine learning model based on the merged respective pairs of neighbor bins. In turn, the method, system, computer program product has provided for improved generation of interpretability data for a target machine learning model which involves consideration of continuous variables having sensitive ranges. Described embodiments leverage and process historical data during post-modeling analysis to identify sensitive ranges for a series of relevant continuous variables. Described embodiments may then generate equal-width bins for the continuous variables considered by a target model, and then calculate overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

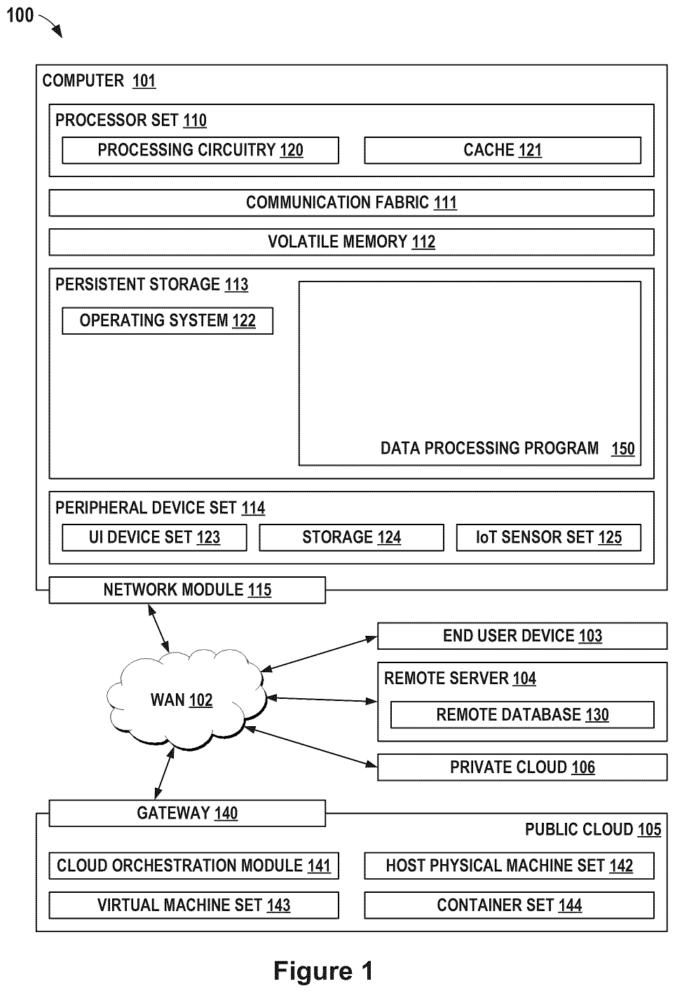

Referring now to FIG. 1, computing environment 100 contains an example of an environment for the execution of at least some of the computer code involved in performing the inventive methods, such as data processing program/code 150. In addition to data processing code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data processing code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data processing code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in data processing program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the data processing program 150 may be a program capable of receiving, for a target machine learning model, historical data including a series of relevant continuous variables. Data processing program 150 may then generate bins for each relevant continuous variable in the series of relevant continuous variables. Next, data processing program 150 may calculate overall sensitivity values for pairs of neighbor bins. Data processing program 150 may then, in response to the calculated overall sensitivity value of respective pairs of neighbor bins being below a predetermined threshold value, merge the respective pairs of neighbor bins. Thereafter, data processing program 150 may generate interpretability data for the target machine learning model based on the merged respective pairs of neighbor bins. In turn, the described method, system, computer program product has provided for improved generation of interpretability data for a target machine learning model which involves consideration of continuous variables having sensitive ranges. Described embodiments leverage and process historical data during post-modeling analysis to identify sensitive ranges for a series of relevant continuous variables. Described embodiments may then generate equal-width bins for the continuous variables considered by a target model, and then calculate overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

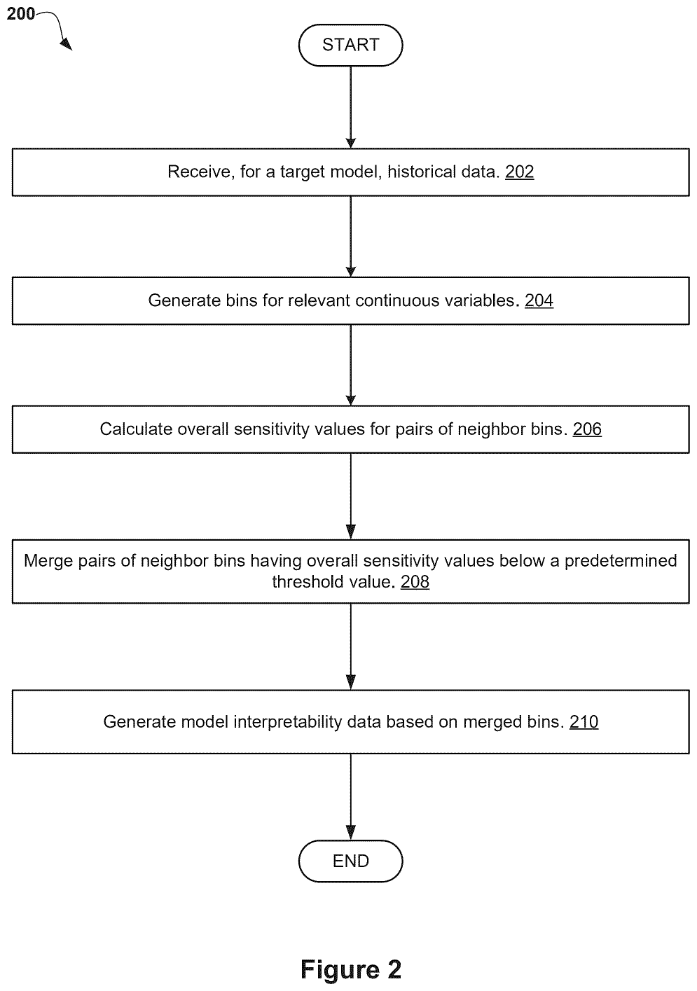

Referring now to FIG. 2, an operational flowchart for an illustrative process 200 of generating interpretability data for a target machine learning model according to at least one embodiment is provided.

At 202, data processing program 150 may receive, for a target machine learning model, historical data including a series of relevant continuous variables. In embodiments, the received historical data may include previously processed data, training data or training datasets, or any combination thereof. In embodiments, the received historical data may include many individual records having a variety of relevant continuous variables therein. The series of relevant continuous variables in the historical data may include (and be referred to as) any features, variables, or inputs considered by the target machine learning model in generating outputs or making predictions. Data processing program 150 will, in subsequent steps, process and analyze the received historical data of the target machine learning model to identify, for respective relevant continuous variables or features, sensitive ranges that may impact the target model's final output or predictions.

At 204, data processing program 150 may generate bins for each relevant continuous variable in the series of relevant continuous variables. In embodiments, the generated bins may be, for example, equal-width bins, where each of the equal-width bins corresponds to a given specific range of values for an associated continuous variable. For example, data processing program 150 may generate exemplary bins ‘B1’, ‘B2’, B3′ . . . ‘Bn” for an exemplary continuous variable ‘X₁’ leveraged by an exemplary target model ‘M1’. In this example, the exemplary target model ‘M1’ may leverage continuous variable ‘X₁’ (among other inputs) to output a predicted ‘Quality of Life’ score for a target person, where ‘X₁’ is a normalized value between 0 and 1 representative of a given person's age. Accordingly, at this step, data processing program 150 may generate a first bin ‘B1’ including all historical data and records where the considered value of continuous variable ‘X₁’ was between 0.1-0.2, a second bin ‘B2’ including all historical data and records where the considered value of continuous variable ‘X₁’ was between 0.2-0.3, and so on. While data processing program 150 may generate bins of equal width with respect to the continuous variables in the received historical data, the number of records in each bin may vary.

At 206, data processing program 150 may then calculate overall sensitivity values for pairs of neighbor bins. In embodiments, the calculated overall sensitivity values may be derived from calculated component variables related to sensitivity of specific ranges of values of respective continuous variables within the series of relevant continuous variables with respect to a target value to be predicted or output by the target machine learning model. For example, in some embodiments, data processing program 150 may calculate the overall sensitivity values based on calculated component variables for neighboring bins including, at least, target variance values, range correlation values, and set correlation values. Thus, the calculated overall sensitivity value for a pair of neighboring bins would be based on a specific range of values of an associated continuous variables corresponding to the neighboring bins being considered, where the sensitivity value will represent how impactful the specific range of values of the associated continuous variable corresponding to the neighboring bins is on the predicted or output value of a given selected target, for example ‘y’, that is being predicted or output by the target machine learning model. This exemplary process of calculating and merging component variables to determine an overall sensitivity value will be described in greater detail below.

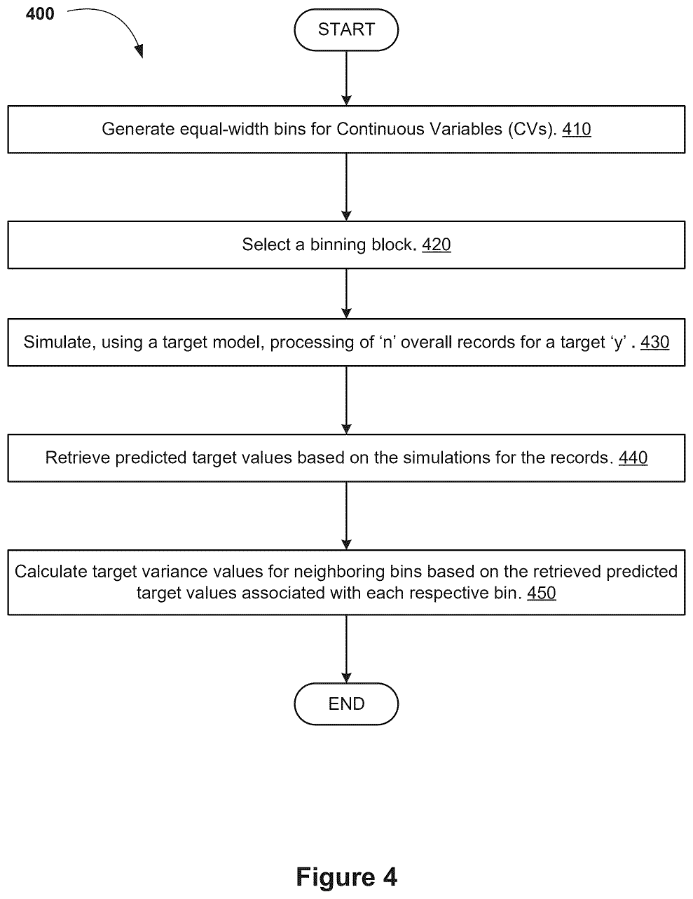

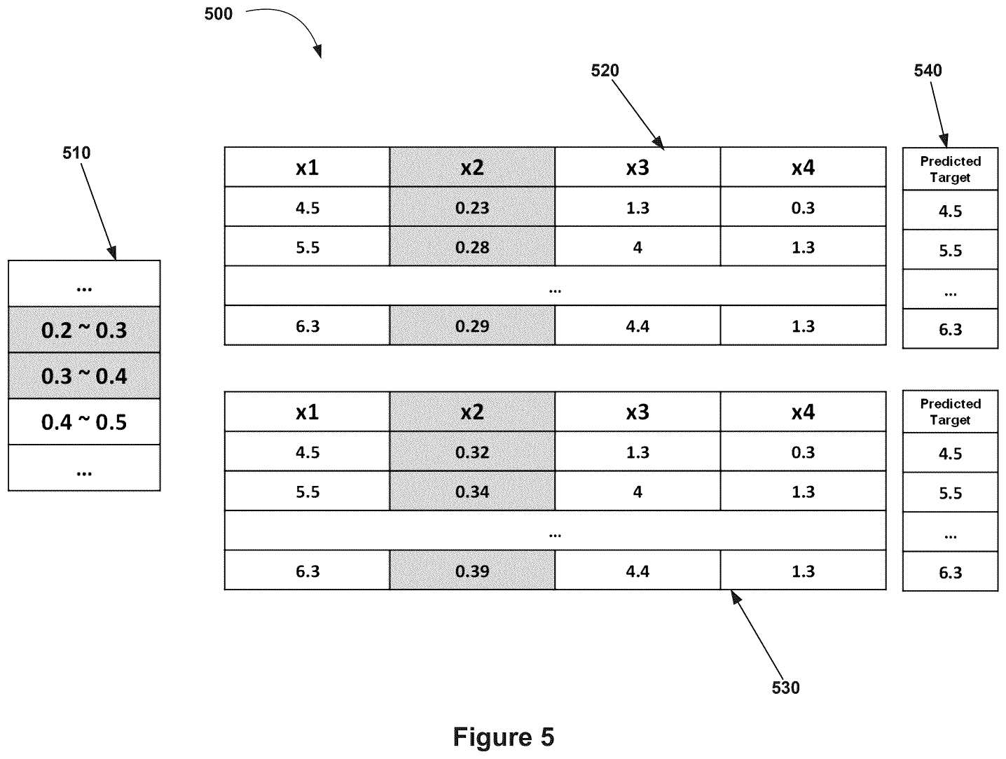

Regarding target variance values, FIG. 4 illustrates an exemplary workflow for an illustrative process 400 of determining target variance values for a pair of neighboring bins associated with historical data (training data, historical runtime data, or a combination thereof) of a target model according to at least one embodiment. In the context of this disclosure, the target variance values represent statistical closeness or statistical distance between values corresponding to predictions or outputs of the target machine learning model for a given target (sometimes represented as ‘y’) for historical data within pairs of selected generated neighboring bins. In embodiments, as shown in FIG. 4, data processing program 150 may be configured to first generate equal width bins for a selected continuous variable at 410. At 420, data processing program 150 may select a binning data block, where the selected binning data block corresponds to one of the generated bins (from step 204) for a specific range of a relevant continuous variable. Next, at 430, data processing program 150 may perform data simulation for processing n overall records using a target model predicting a given target ‘y’. At 440, data processing program 150 may then, for each binning block, retrieve predicted target values for a given exemplary target ‘y’ based on the simulations at 430 for each of the ‘n’ records. Thereafter, at 450, data processing program 150 may calculate, for neighboring bins, target variance values for the predicted target (‘y’) based on the retrieved predicted target values associated with each of the respective bins of each pair of neighboring bins. In embodiments, if the calculated target variance values for the predicted target for a pair of neighboring bins is less than a predetermined threshold value, data processing program 150 may be configured to flag the neighboring bins as optionally mergeable. This process is further depicted in FIG. 5.

FIG. 5 illustrates exemplary tables depicting, for a target model, an exemplary training dataset including a series of continuous variables that have been sorted by equal width binning for a selected variable ‘X₂’, and associated target variance values based on simulating records of the training dataset according to at least one embodiment. In FIG. 5, a table 500 includes a key 510 illustrating exemplary ranges for a series of exemplary generated equal width bins corresponding to exemplary training dataset received by data processing program 150. Individual records of the exemplary training dataset are depicted within each row of an upper table 520, and a lower table 530. In embodiments, data processing program 150 may generate a first bin including records of the exemplary training data set which had exemplary continuous variable ‘x2’ ranging from 0.2 to 0.3, depicted within upper table 520, and a second bin including records of the exemplary training data set which had exemplary continuous variable ‘x2’ ranging from 0.3 to 0.4, depicted within lower table 530. Each horizontal row of FIG. 5 depicts an individual record of the exemplary training dataset, and the values of a relevant series of continuous variables considered by the target machine learning model, represented by ‘x1’, ‘x2’, ‘x3’, and ‘x4’ respectively. FIG. 5 further includes a predicted target column at 540 which includes the values output by thee target machine learning model for an exemplary target, such as previously discussed exemplary target ‘y’. In embodiments involving historical data that includes training data, such as FIG. 5, data processing program 150 may simulate individual records within the training data to obtain the predicted values for the target output by the machine learning model. The values depicted in the predicted target column at 540 for each of the neighboring bins, in this case the prediction columns corresponding to upper table 520, and lower table 530 respectively, may then be leveraged to calculate target variance values for the exemplary predicted target between the neighboring bins. For the exemplary training data shown in FIG. 5, it would be expected that the calculated target variance values for the predicted target between the shown exemplary neighboring bins would likely be relatively low, as the values in the predicted target column do not seem sensitive to changing the value of exemplary continuous variable ‘x2’. In other words, the output of the target machine learning model for the predicted target ‘y’ is not particularly sensitive to changes to the value of the exemplary continuous variable ‘x2’ when the value of that variable is within the ranges of the two depicted neighboring bins. This may be an indication that the target machine learning model is not particularly sensitive in this range, and that these neighboring bins may be mergeable. Accordingly, the calculated target variance values between neighboring bins may be leveraged as a component for calculating the overall sensitivity value for neighboring bins associated with a selected continuous variable.

In some embodiments, data processing program 150 may further calculate range correlation values between the continuous variables to leverage as a component in calculating an overall sensitivity value for a pair of neighboring bins. The calculated range correlation values between pairs of continuous variables, like the calculated target variance values discussed above, may influence whether data processing program 150 will ultimately merge a pair of neighboring bins, as it affects the overall calculated sensitivity values. Calculating range correlation values between the considered continuous variables are especially useful in scenarios in which selected continuous variables are only highly impactful on the output or prediction of the machine learning model within certain ranges of the selected continuous variable. For example, in an exemplary embodiment, data processing program 150 may be employed with an exemplary target machine learning model ‘M1’ that is configured to output a predicted value for an exemplary target ‘Y’ based on exemplary continuous variables including exemplary variable ‘V1’ for body mass index (BMI), and exemplary variable ‘V2’ for age. In this embodiment, data processing program 150 may calculate range correlation values for neighboring bins associated with exemplary variable ‘V2’ for age. The calculated range correlation value may reflect that if the value of ‘V2’ for age is less than 30, it has no correlation with exemplary variable ‘V1’ for BMI, while the calculated range correlation values for another pair of bins may reflect that if the value of ‘V2’ for age is greater than 50, there is a strong correlation with exemplary variable ‘V1’ for BMI. In embodiments, data processing program 150 may be configured to calculate the range correlation values between continuous variables using suitable known methods and may further be configured to normalize the calculated range correlation values. Typically, if the range correlation values calculated by data processing program 150 demonstrate that the historical datasets include a high correlation between selected continuous variables for neighboring bins, any merging operations will affect the datasets greatly and cause significant information drop or knowledge gaps. Conversely, if the range correlation values calculated by data processing program 150 demonstrate that the historical datasets include a low correlation between selected continuous variables for neighboring bins, then merging operations are less likely to cause harmful information drops or knowledge gaps.

In embodiments, data processing program 150 may further calculate set correlation values for a selected binning block and a neighbor bin. This may involve data processing program 150 employing one or more multiple known algorithms to calculate an overall correlation value between neighboring bins. For example, in embodiments, data processing program 150 may perform Principal component analyses (PCA) by employing any suitable known algorithms to identify any principal components that may explain variance between two neighbor bins, or to represent the relationships between the two variables in terms of a first principal component. In embodiments, data processing program 150 may perform distance correlation analyses using any known or suitable algorithms. This may be particularly useful in scenarios in which the historical datasets include many continuous variables ranging from [0,1] that have been normalized. This type of analysis may provide valuable insight into relations between ranges of the continuous variables, capturing information related to non-linear dependences, or other complex dependency structures in the historical datasets. In embodiments, data processing program 150 may further perform cluster analyses using any suitable known algorithms, identifying ranges or data segments where two neighboring bins or data therein may have similar cluster patterns or structures, implying high correlation. In embodiments, data processing program 150 may select any one of the above-described algorithms, or alternatively leverage a combination thereof as may be useful for different environments or target models.

In embodiments, data processing program 150 may calculate a mean value of neighbor correlation values for one binning block to represent a calculated set correlation value to be leveraged as a variable or component in calculating the overall sensitivity values for neighboring bins. For example, if an exemplary binning block has an upper block portion and a lower block portion, data processing program 150 may calculate the mean value of the neighbor correlation values for the upper and lower block to represent a set correlation value for the exemplary bin block to which they each belong. Unlike the range correlation values discussed above, the calculated set correlation values have an opposing impact on determining the probability of a merge operation being appropriate. That is, for the calculated set correlation value, a relatively low set correlation value typically would result in less information loss and higher probabilities of merge.

Thereafter, once data processing program 150 has calculated the above-described values as component variables, it may calculate the overall sensitivity value. In embodiments, for example, data processing program 150 may calculate the overall sensitivity value using the following exemplary formula:

$$OverallSensitivityValue = \frac{wtv * TV + {\sum }_{i = 0}^{n - 1} wrc [ i ] * \vert RC \vert + {ws}_{c} * SC}{n + 2}$$

In the above exemplary formula, each ‘w’ represents a weight for a given continuous variable, ‘TV’ represents the calculated target variance value, ‘RC’ represents calculated range correlation values, and ‘SC’ represents calculated set correlation values, where ‘n’ represents a total number of predictors.

At 208, data processing program 150 may, in response to the calculated sensitivity value of respective pairs of neighbor bins being below a predetermined threshold value, merge the respective pairs of neighbor bins. In embodiments, data processing program 150 may be configured to flag certain neighboring bins as mergeable if the calculated overall sensitivity value is less than a predetermined threshold value. The predetermined threshold value may be adjusted as is desirable for the target machine learning model and the environment or setting in which data processing program 150 is being employed. At this step, data processing program 150 may essentially merge the neighboring bins which have been flagged as mergeable.

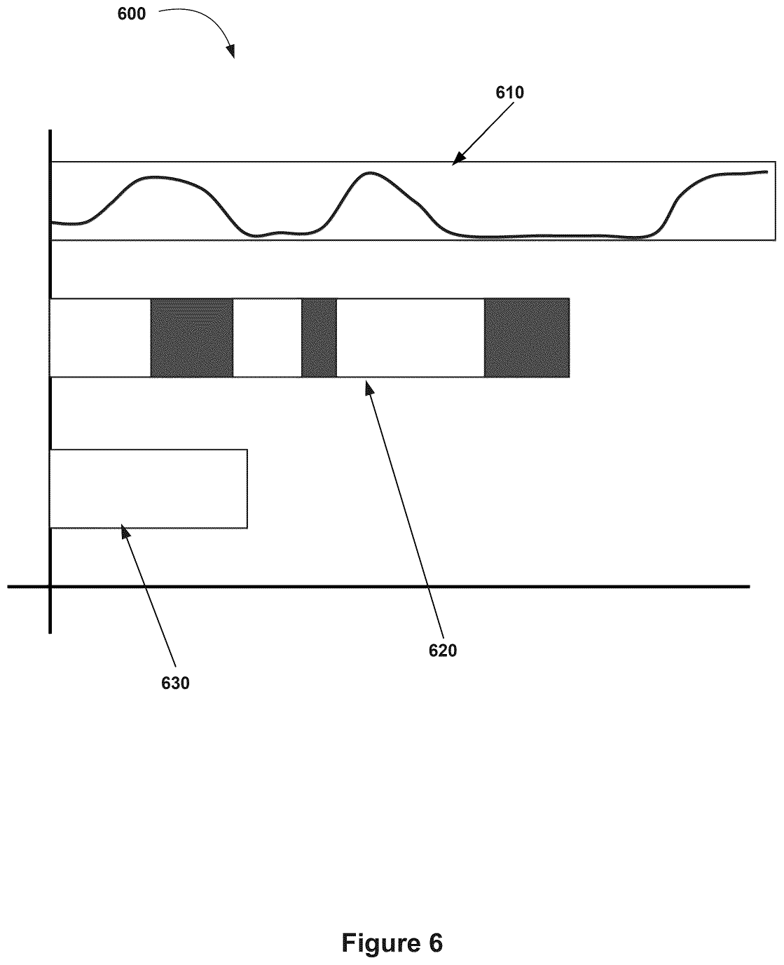

At 210, data processing program may generate interpretability data for the target machine learning model based on the merged respective pairs of neighbor bins. FIG. 6 depicts exemplary interpretability data that may be output after performing an exemplary process of generating interpretability data for a target machine learning model according to at least one embodiment. As shown in FIG. 6, in embodiments, data processing program 150 may output a conventional simple bar plot 630, representing a static value that may be normalized and used to rank the continuous variables of the target machine learning model based on importance or impact. However, based on the data calculated and determined using the above-described methods, data processing program 150 may further generate, for each of the continuous variables, a bar chart 610 having a line appended thereto which depicts the sensitive ranges for the series of continuous variables with respect to a given target to be predicted or output by the target machine learning model. In embodiments, the line may correspond to the calculated overall sensitivity values for different values of respective selected continuous variables from the series of relevant continuous variables with respect to the given target to be predicted or output by the target machine learning model. In embodiments, the line appended to bar chart 610 may be generated by determining a series of best fit lines between calculated overall sensitivity values for different ranges of the selected continuous variable. Similarly, in embodiments, data processing program 150 may generate, for each of the continuous variables, a bar chart 620, which may be color-coded (or otherwise sorted and differentiated using suitable visual representations, such as different line patterns or symbols) to depict ranges or bins for the continuous variable that have been flagged as mergeable, or non-mergeable based on calculated overall sensitivity values. It may be understood that the depicted color-coded regions are further based upon the calculated variance and correlation values discussed above, as these are component variables for the calculated overall sensitivity value.

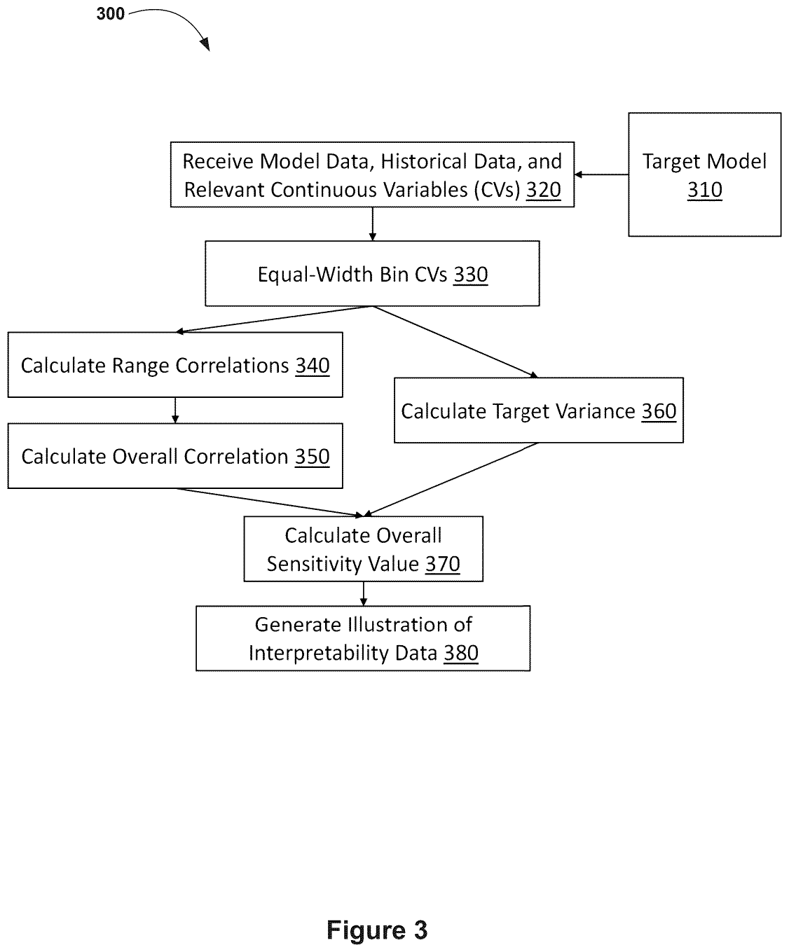

FIG. 3 illustrates an exemplary workflow for an illustrative process 300 of generating interpretability data for a target machine learning model according to at least one embodiment. Illustrative process 300 may be performed by data processing program 150 in an exemplary embodiment that is similar to above-described illustrative process 200 and may be better understood in the context of the previously discussed methods. In FIG. 3, illustrative process 300 includes a target model 310. Data processing program 150 may then, at 320, receive model data, historical data, and relevant Continuous Variables (CVs). Data processing program 150 may then generate equal-width bins for the CVs at 330. At 340, 350, and 360 respectively, data processing program 150 may calculate range correlation, overall correlation, and target variance values for the Equal-width bins corresponding to the CVs. These calculated values may then be merged and leveraged at 370 to calculate overall sensitivity values. Based on the overall calculated sensitivity values, data processing program 150 may then generate illustrations of interpretability data at 380 for the target model which, as discussed above, may visually depict and represent sensitive ranges for the continuous variables, providing more comprehensive insights for the target model as compared to conventional static feature or continuous variable rankings.

It may be appreciated that data processing program 150 has thus provided for improved generation of interpretability data for a target machine learning model which involves consideration of continuous variables having sensitive ranges. Described embodiments leverage and process historical data during post-modeling analysis to identify sensitive ranges for a series of relevant continuous variables. Described embodiments may then generate equal-width bins for the continuous variables considered by a target model, and then calculate overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

Presently described embodiments may relate to the following clauses:

Clause 1: A computer-based method of generating interpretability data for a target machine learning model by determining sensitive ranges of continuous variables for post-modeling analysis, the method including: receiving, for the target machine learning model, historical data including a series of relevant continuous variables, generating bins for each relevant continuous variable in the series of relevant continuous variables, calculating overall sensitivity values for pairs of neighbor bins, in response to the calculated overall sensitivity value of respective pairs of neighbor bins being below a predetermined threshold value, merging the respective pairs of neighbor bins; and, generating interpretability data for the target machine learning model based on the merged respective pairs of neighbor bins. Described embodiments thus provide for improved generation of interpretability data for a target machine learning model which involves consideration of continuous variables having sensitive ranges. Described embodiments leverage and process historical data during post-modeling analysis to identify sensitive ranges for a series of relevant continuous variables by generating equal-width bins for the continuous variables considered by a target model, and then calculating overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

Clause 2: The computer-based method of clause 1, wherein the received historical data for the target machine learning model comprises previously processed data, training datasets, or a combination thereof. This allows described embodiments to leverage any received data, before or after the target model has been fully deployed or in use, such that described embodiments may generate interpretability data for the target model which depicts sensitive ranges for continuous variables as it relates to a predictable target value that may be output by the target machine learning model.

Clause 3: The computer-based method of any of the preceding clauses 1-2, wherein the generated bins for each of the relevant continuous variables in the series of relevant continuous variables comprise equal-width bins, wherein each of the equal-width bins corresponds to a given range of values of an associated continuous variable. This allows described embodiments to partition the received historical data into groupings of individual records or datasets that may be used to generate interpretability data specific to groupings of ranges of values for continuous variables, rather than outputting normalized interpretability data for the overall impact or ranking of a given continuous variable or feature considered by the target model.

Clause 4: The computer-based method of any of the preceding clauses 1-3, wherein the calculated overall sensitivity values are derived from calculated component variables related to sensitivity of specific ranges of values of respective continuous variables within the series of relevant continuous variables with respect to a target value to be predicted or output by the target machine learning model. This allows described embodiments to be more flexible and comprehensive, as described embodiments may be configured to include more or less component variables to capture additional data, information, or variables related to a given continuous variable or feature being considered. As more component variables are considered by described embodiments, the generated interpretability data for the target model may capture more information related to sensitive ranges of a continuous variable as it relates to a target value to be predicted or output by the target machine learning model.

Clause 5: The computer-based method of any of the preceding clauses 1-4, wherein the calculated overall sensitivity values are derived from calculated component variables including, at least, target variance values, range correlation values, and set correlation values for the pairs of neighbor bins. This allows described embodiments to generate interpretability data which captures specific information related to variance, range correlation data, and set correlation data between neighboring bins which may be related to sensitive ranges for continuous variables associated with the neighboring bins, as it relates to a target value to be predicted or output by the target machine learning model.

Clause 6: The computer-based method of any of the preceding clauses 1-5, wherein the generated interpretability data depicts sensitive ranges of selected continuous variables from the series of continuous variables with respect to a given target to be predicted or output by the target machine learning model. This allows described embodiments to output the determined sensitive ranges for each of the relevant continuous variables in a format that is usable by an end user to help provide useful insights and explainability for the target model, specifically when compared to typical bar chart figures which merely depict feature or variable importance or rankings as a static value or metric.

Clause 7: The computer-based method of any of the preceding clauses 1-6, wherein the generated interpretability data comprises a bar chart having a line appended thereto, the line corresponding to the calculated overall sensitivity values for different values of respective selected continuous variables from the series of relevant continuous variables with respect to the given target to be predicted or output by the target machine learning model. This allows described embodiments to output an alternative visual depiction of the generated interpretability data for the target model which provides more specific information when compared to a color-coded bar chart, as the line appended to the bar chart captures values in between certain calculated datapoints.

Clause 8: A computer system including: one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method including: receiving, for the target machine learning model, historical data including a series of relevant continuous variables, generating bins for each relevant continuous variable in the series of relevant continuous variables, calculating overall sensitivity values for pairs of neighbor bins, in response to the calculated overall sensitivity value of respective pairs of neighbor bins being below a predetermined threshold value, merging the respective pairs of neighbor bins; and, generating interpretability data for the target machine learning model based on the merged respective pairs of neighbor bins. Described embodiments thus provide for improved generation of interpretability data for a target machine learning model which involves consideration of continuous variables having sensitive ranges. Described embodiments leverage and process historical data during post-modeling analysis to identify sensitive ranges for a series of relevant continuous variables by generating equal-width bins for the continuous variables considered by a target model, and then calculating overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

Clause 9: The computer system of clause 8, wherein the received historical data for the target machine learning model comprises previously processed data, training datasets, or a combination thereof. This allows described embodiments to leverage any received data, before or after the target model has been fully deployed or in use, such that described embodiments may generate interpretability data for the target model which depicts sensitive ranges for continuous variables as it relates to a predictable target value that may be output by the target machine learning model.

Clause 10: The computer system of any of the preceding clauses 8-9, wherein the generated bins for each of the relevant continuous variables in the series of relevant continuous variables comprise equal-width bins, wherein each of the equal-width bins corresponds to a given range of values of an associated continuous variable. This allows described embodiments to partition the received historical data into groupings of individual records or datasets that may be used to generate interpretability data specific to groupings of ranges of values for continuous variables, rather than outputting normalized interpretability data for the overall impact or ranking of a given continuous variable or feature considered by the target model.

Clause 11: The computer system of any of the preceding clauses 8-10, wherein the calculated overall sensitivity values are derived from calculated component variables related to sensitivity of specific ranges of values of respective continuous variables within the series of relevant continuous variables with respect to a target value to be predicted or output by the target machine learning model. This allows described embodiments to be more flexible and comprehensive, as described embodiments may be configured to include more or less component variables to capture additional data, information, or variables related to a given continuous variable or feature being considered. As more component variables are considered by described embodiments, the generated interpretability data for the target model may capture more information related to sensitive ranges of a continuous variable as it relates to a target value to be predicted or output by the target machine learning model.

Clause 12: The computer system of any of the preceding clauses 8-11, wherein the calculated overall sensitivity values are derived from calculated component variables including, at least, target variance values, range correlation values, and set correlation values for the pairs of neighbor bins. This allows described embodiments to generate interpretability data which captures specific information related to variance, range correlation data, and set correlation data between neighboring bins which may be related to sensitive ranges for continuous variables associated with the neighboring bins, as it relates to a target value to be predicted or output by the target machine learning model.

Clause 13: The computer system of any of the preceding clauses 8-12, wherein the generated interpretability data depicts sensitive ranges of selected continuous variables from the series of continuous variables with respect to a given target to be predicted or output by the target machine learning model. This allows described embodiments to output the determined sensitive ranges for each of the relevant continuous variables in a format that is usable by an end user to help provide useful insights and explainability for the target model, specifically when compared to typical bar chart figures which merely depict feature or variable importance or rankings as a static value or metric.

Clause 14: The computer system of any of the preceding clauses 8-13, wherein the generated interpretability data comprises a bar chart having a line appended thereto, the line corresponding to the calculated overall sensitivity values for different values of respective selected continuous variables from the series of relevant continuous variables with respect to the given target to be predicted or output by the target machine learning model. This allows described embodiments to output an alternative visual depiction of the generated interpretability data for the target model which provides more specific information when compared to a color-coded bar chart, as the line appended to the bar chart captures values in between certain calculated datapoints.

Clause 15: A computer program product, the computer program product including: one or more computer-readable tangible storage medium and program instructions stored on at least one of the one or more computer-readable tangible storage medium, the program instructions executable by a processor capable of performing a method, the method including: receiving, for the target machine learning model, historical data including a series of relevant continuous variables, generating bins for each relevant continuous variable in the series of relevant continuous variables, calculating overall sensitivity values for pairs of neighbor bins, in response to the calculated overall sensitivity value of respective pairs of neighbor bins being below a predetermined threshold value, merging the respective pairs of neighbor bins; and, generating interpretability data for the target machine learning model based on the merged respective pairs of neighbor bins. Described embodiments thus provide for improved generation of interpretability data for a target machine learning model which involves consideration of continuous variables having sensitive ranges. Described embodiments leverage and process historical data during post-modeling analysis to identify sensitive ranges for a series of relevant continuous variables by generating equal-width bins for the continuous variables considered by a target model, and then calculating overall sensitivity values for neighboring bins which are derived from a number of other calculated values, such target variance values, range correlation values, and set correlation values. Described embodiments may merge neighboring bins which have overall sensitivity values below a predetermined threshold. This allows described embodiments to generate improved interpretability data for the target machine learning model based on the merged respective pairs of neighbor bins which reflects the sensitive ranges for the relevant continuous variables considered by the target model, and therefore provides improved and more comprehensive insights and explainability related to the target model.

Clause 16: The computer program product of clause 15, wherein the received historical data for the target machine learning model comprises previously processed data, training datasets, or a combination thereof. This allows described embodiments to leverage any received data, before or after the target model has been fully deployed or in use, such that described embodiments may generate interpretability data for the target model which depicts sensitive ranges for continuous variables as it relates to a predictable target value that may be output by the target machine learning model.

Clause 17: The computer program product of any of the preceding clauses 15-16, wherein the generated bins for each of the relevant continuous variables in the series of relevant continuous variables comprise equal-width bins, wherein each of the equal-width bins corresponds to a given range of values of an associated continuous variable. This allows described embodiments to partition the received historical data into groupings of individual records or datasets that may be used to generate interpretability data specific to groupings of ranges of values for continuous variables, rather than outputting normalized interpretability data for the overall impact or ranking of a given continuous variable or feature considered by the target model.

Clause 18: The computer program product of any of the preceding clauses 15-17, wherein the calculated overall sensitivity values are derived from calculated component variables related to sensitivity of specific ranges of values of respective continuous variables within the series of relevant continuous variables with respect to a target value to be predicted or output by the target machine learning model. This allows described embodiments to be more flexible and comprehensive, as described embodiments may be configured to include more or less component variables to capture additional data, information, or variables related to a given continuous variable or feature being considered. As more component variables are considered by described embodiments, the generated interpretability data for the target model may capture more information related to sensitive ranges of a continuous variable as it relates to a target value to be predicted or output by the target machine learning model.

Clause 19: The computer program product of any of the preceding clauses 15-18, wherein the calculated overall sensitivity values are derived from calculated component variables including, at least, target variance values, range correlation values, and set correlation values for the pairs of neighbor bins. This allows described embodiments to generate interpretability data which captures specific information related to variance, range correlation data, and set correlation data between neighboring bins which may be related to sensitive ranges for continuous variables associated with the neighboring bins, as it relates to a target value to be predicted or output by the target machine learning model.

Clause 20: The computer program product of any of the preceding clauses 15-19, wherein the generated interpretability data depicts sensitive ranges of selected continuous variables from the series of continuous variables with respect to a given target to be predicted or output by the target machine learning model. This allows described embodiments to output the determined sensitive ranges for each of the relevant continuous variables in a format that is usable by an end user to help provide useful insights and explainability for the target model, specifically when compared to typical bar chart figures which merely depict feature or variable importance or rankings as a static value or metric.

It may be appreciated that FIGS. 2-6 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of generating interpretability data for a target machine learning model by determining sensitive ranges of continuous variables for post-modeling analysis, the method comprising:
receiving, for the target machine learning model, historical data including a series of relevant continuous variables;
generating bins for each relevant continuous variable in the series of relevant continuous variables;
calculating overall sensitivity values for pairs of neighbor bins;
in response to the calculated overall sensitivity value of respective pairs of neighbor bins being below a predetermined threshold value, merging the respective pairs of neighbor bins; and
generating interpretability data for the target machine learning model based on the merged respective pairs of neighbor bins.

2. The computer-based method of claim 1, wherein the received historical data for the target machine learning model comprises previously processed data, training datasets, or a combination thereof.

3. The computer-based method of claim 1, wherein the generated bins for each of the relevant continuous variables in the series of relevant continuous variables comprise equal-width bins, wherein each of the equal-width bins corresponds to a given range of values of an associated continuous variable.

4. The computer-based method of claim 1, wherein the calculated overall sensitivity values are derived from calculated component variables related to sensitivity of specific ranges of values of respective continuous variables within the series of relevant continuous variables with respect to a target value to be predicted or output by the target machine learning model.

5. The computer-based method of claim 4, wherein the calculated overall sensitivity values are derived from calculated component variables including, at least, target variance values, range correlation values, and set correlation values for the pairs of neighbor bins.

6. The computer-based method of claim 1, wherein the generated interpretability data depicts sensitive ranges of selected continuous variables from the series of continuous variables with respect to a given target to be predicted or output by the target machine learning model.

7. The computer-based method of claim 6, wherein the generated interpretability data comprises a bar chart having a line appended thereto, the line corresponding to the calculated overall sensitivity values for different values of respective selected continuous variables from the series of relevant continuous variables with respect to the given target to be predicted or output by the target machine learning model.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving, for the target machine learning model, historical data including a series of relevant continuous variables;
generating bins for each relevant continuous variable in the series of relevant continuous variables;
calculating overall sensitivity values for pairs of neighbor bins;
in response to the calculated overall sensitivity value of respective pairs of neighbor bins being below a predetermined threshold value, merging the respective pairs of neighbor bins; and
generating interpretability data for the target machine learning model based on the merged respective pairs of neighbor bins.

9. The computer system of claim 8, wherein the received historical data for the target machine learning model comprises previously processed data, training datasets, or a combination thereof.

10. The computer system of claim 8, wherein the generated bins for each of the relevant continuous variables in the series of relevant continuous variables comprise equal-width bins, wherein each of the equal-width bins corresponds to a given range of values of an associated continuous variable.

11. The computer system of claim 8, wherein the calculated overall sensitivity values are derived from calculated component variables related to sensitivity of specific ranges of values of respective continuous variables within the series of relevant continuous variables with respect to a target value to be predicted or output by the target machine learning model.

12. The computer system of claim 11, wherein the calculated overall sensitivity values are derived from calculated component variables including, at least, target variance values, range correlation values, and set correlation values for the pairs of neighbor bins.

13. The computer system of claim 8, wherein the generated interpretability data depicts sensitive ranges of selected continuous variables from the series of continuous variables with respect to a given target to be predicted or output by the target machine learning model.

14. The computer system of claim 13, wherein the generated interpretability data comprises a bar chart having a line appended thereto, the line corresponding to the calculated overall sensitivity values for different values of respective selected continuous variables from the series of relevant continuous variables with respect to the given target to be predicted or output by the target machine learning model.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving, for the target machine learning model, historical data including a series of relevant continuous variables;
generating bins for each relevant continuous variable in the series of relevant continuous variables;
calculating overall sensitivity values for pairs of neighbor bins;
in response to the calculated overall sensitivity value of respective pairs of neighbor bins being below a predetermined threshold value, merging the respective pairs of neighbor bins; and
generating interpretability data for the target machine learning model based on the merged respective pairs of neighbor bins.

16. The computer program product of claim 15, wherein the received historical data for the target machine learning model comprises previously processed data, training datasets, or a combination thereof.

17. The computer program product of claim 15, wherein the generated bins for each of the relevant continuous variables in the series of relevant continuous variables comprise equal-width bins, wherein each of the equal-width bins corresponds to a given range of values of an associated continuous variable.

18. The computer program product of claim 15, wherein the calculated overall sensitivity values are derived from calculated component variables related to sensitivity of specific ranges of values of respective continuous variables within the series of relevant continuous variables with respect to a target value to be predicted or output by the target machine learning model.

19. The computer program product of claim 18, wherein the calculated overall sensitivity values are derived from calculated component variables including, at least, target variance values, range correlation values, and set correlation values for the pairs of neighbor bins.

20. The computer program product of claim 15, wherein the generated interpretability data depicts sensitive ranges of selected continuous variables from the series of continuous variables with respect to a given target to be predicted or output by the target machine learning model.
